(19) United States
(12) Patent Application Publication
(10) Pub. No.: US 2016/0091997 A1
(43) Pub. Date: Mar. 31, 2016

(54) TOUCH PANEL HAVING RELATIVELY NARROW TRACE AREA AND MANUFACTURING METHOD THEREOF

(71) Applicant: Henghao Technology Co., Ltd., Hsinchu County (TW)

(72) Inventors: Ming-Hsien Ho, Hsinchu County (TW); Che-Sheng Chang, Hsinchu County (TW)

(21) Appl. No.: 14/863,549

(22) Filed: Sep. 24, 2015

(30) Foreign Application Priority Data
Sep. 26, 2014 (TW) 103133641

(51) Int. Cl. G06F 3/041

(52) U.S. Cl. CPC G06F 3/041; G06F 2203/04103

(57) ABSTRACT

Configurations of a touch panel having a relatively narrow trace area and a manufacturing method thereof are disclosed. In the proposed touch panel, the trace area includes a grounding layer, a first insulating layer configured on the grounding layer, and a first sensor trace configured on the first insulating layer.

### CROSS-REFERENCES TO RELATED APPLICATIONS

This application claims the benefits of Taiwan Patent Application Number 103133641 filed on Sep. 26, 2014, at the Taiwan Intellectual Property Office, the disclosures of which are incorporated herein in their entirety by reference.

### FIELD OF THE INVENTION

The present invention relates to a touch panel having a relatively narrow trace area and a manufacturing method thereof, in particular to a touch panel having a trace area with a grounding layer, a first insulating layer configured on the grounding layer, and a first sensor trace configured on the first insulating layer, and a manufacturing method thereof.

### BACKGROUND OF THE INVENTION

Among development trends for touch panels, a touch panel with a trace area with a relatively narrow size compared to a conventional touch panel such that users can use a touch panel with a relatively larger screen is a trend recently welcomed by the users.

FIG. 1 shows a schematic diagram of a trace area and sensors in a conventional touch panel with a glass-film-film (GFF) structure. In FIG. 1, the touch panel 1 includes a trace area 10 and plural sensors, wherein each sensor includes a transmitter 11 and a receiver 12. The trace area 10 includes plural first sensor traces 13, plural second sensor traces 14 and plural grounding traces 15, wherein each first sensor trace 13 is a transmitter trace with one end connected to a transmitter 11, and each second sensor trace 14 is a receiver trace with one end connected to a receiver 12. The transmitter trace and the receiver trace above can both be commonly named as a sensor trace. The transmitter 11 and the receiver 12 as shown in FIG. 1 can be exchanged with each other. That is to say, in a different embodiment of the prior art, there can be plural (receivers) 11 and plural (transmitters) 12, and the plural first sensor traces 13 are plural receiver traces, and the plural second sensor traces 14 are then plural transmitter traces.

Touch panels with a relatively narrow frame (that is the trace area) can be configured with a relatively large touch screen, which is increasingly welcomed by users. Thus, how to design a touch panel with a relatively narrow trace area is worthy of further research and improvement.

Keeping the drawbacks of the prior art in mind, and through the use of robust and persistent experiments and research, the applicant has finally conceived of a touch panel having a relatively narrow trace area and a manufacturing method thereof.

### SUMMARY OF THE INVENTION

It is an objective of the present invention to disclose a touch panel having a trace area with a first trace layer and a second trace layer, wherein the first trace layer and the second trace layer area are located at different vertical levels, and because the touch panel has a relatively narrow frame, a relatively large touch screen can be configured thereon.

In accordance with the first aspect of the present invention, a touch panel comprises a trace area, wherein the trace area includes a grounding layer, a first insulating layer configured on the grounding layer, and a first sensor trace configured on the first insulating layer.

In accordance with the second aspect of the present invention, a touch panel comprises a trace area, wherein the trace area includes a cross section and the cross section includes by height: a first trace layer, a second trace layer, and an insulating layer configured between the first trace layer and the second trace layer.

In accordance with the third aspect of the present invention, a manufacturing method for a touch panel comprises: providing a trace area including a grounding layer, a first insulating layer and a first sensor trace; configuring the first insulating layer on the grounding layer; and configuring the first senor trace on the first insulating layer.

### BRIEF DESCRIPTION OF THE DRAWINGS

Other objectives, advantages and efficacy of the present invention will be described in detail below taken from the preferred embodiments with reference to the accompanying drawings, in which:

FIG. 1 is a schematic diagram of a trace area and sensors in a conventional touch panel structure.

FIG. 2(a) is a schematic diagram of a cross section of a trace area in a conventional touch panel structure.

FIG. 2(b) is a schematic diagram of a cross section of a trace area and sensors in a touch panel structure according to the first preferred embodiment of the present invention.

FIG. 3(a) is a schematic diagram of a trace area and sensors in a conventional touch panel structure.

FIG. 3(b) is a schematic diagram of a cross section of a trace area and sensors in a touch panel according to the second preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; they are not intended to be exhaustive or to be limited to the precise form disclosed.

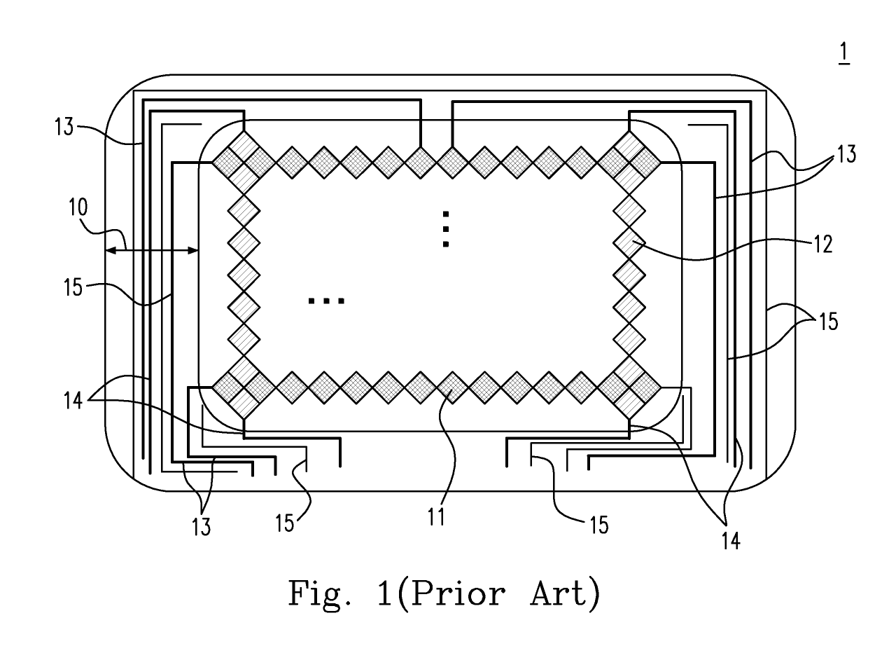

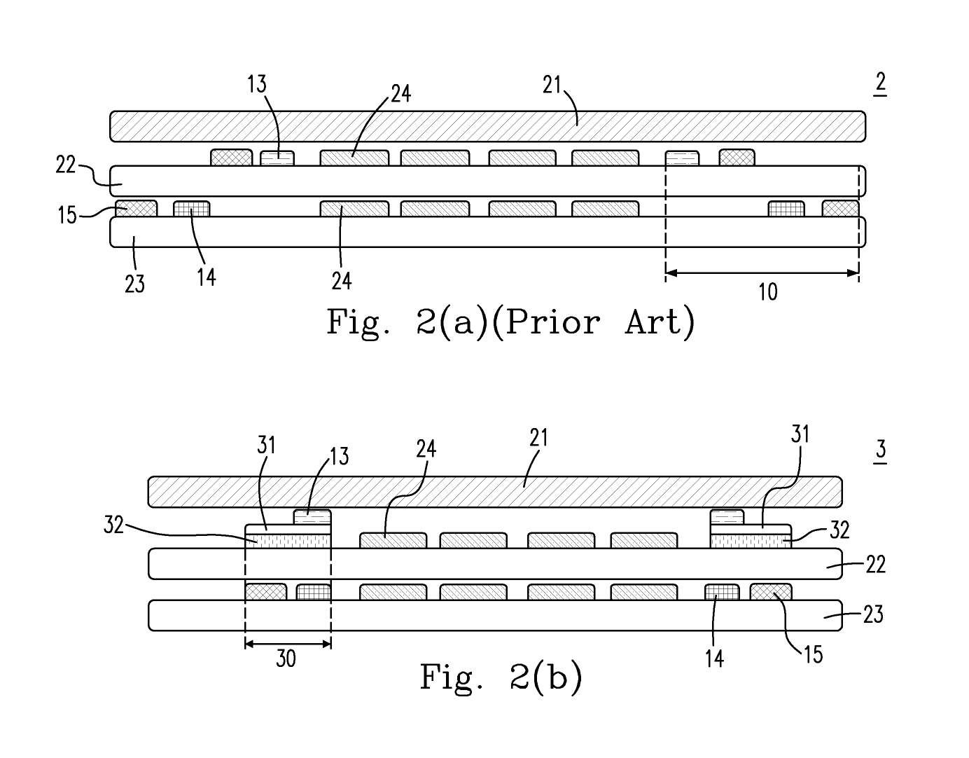

FIG. 2(a) shows a schematic diagram of a cross section of a trace area in a conventional touch panel structure. In FIG. 2(a), the touch panel 2 includes a cover glass 21, a first substrate 22, a second substrate 23, a plurality of ITO sensors 24, a plurality of first sensor traces 13, a plurality of second sensor traces 14 and a plurality of grounding traces 15. As shown in FIG. 2(a), in the central areas of both the first substrate 22 and the second substrate 23, there are a plurality of ITO sensors 24 configured thereon. At the right-hand side of FIG. 2(a), there is a trace area 10. One embodiment of this trace area 10 is a rectangular area surrounding the border of the touch panel 2 (see FIG. 1). The trace area 10 also includes other embodiments of non-rectangular area. For example, the trace area 10 can be in a “ [symbol] ” shape etc. In the trace area 10, a first trace layer and a second trace layer are included, wherein the first trace layer includes the first substrate 22, and a plurality of first sensor traces 13 and a plurality of grounding traces 15 both configured on the first substrate 22. The second trace layer includes the second substrate 23, and a plurality of second sensor traces 14 and a plurality of grounding traces 15 both configured on the second substrate 23. As described above, each first sensor trace 13 is a transmitter trace, each second sensor trace 14 is a receiver trace, and the transmitter trace and the receiver trace can be commonly named as a sensor trace. As mentioned above, in a different embodiment of the prior art, it is also possible that the first sensor trace 13 is a receiver trace, and the second sensor trace 14 is a transmitter trace. To avoid each sensor trace generating interference with other sensor traces above or below them, the second trace layer of the trace area 10 has a space located under each sensor trace 13/14 on the first trace layer as shown in FIG. 2(a). Similarly, the first trace layer of the trace area 10 also has a space located above each sensor trace 13/14 on the second trace layer. Thus, a substantial amount of space in the trace area 10 is wasted and this can surely be improved.

FIG. 2(b) shows a schematic diagram of a cross section of a trace area and sensors in a touch panel structure according to the first preferred embodiment of the present invention. In FIG. 2(b), the touch panel 3 includes a cover glass 21, a first substrate 22 and a second substrate 23, a plurality of ITO sensors 24, a plurality of first sensor traces 13, a plurality of second sensor traces 14, a plurality of grounding traces 15, a plurality of insulating layers 31 and a plurality of grounding layers 32. The differences between FIG. 2(b) and FIG. 2(a) are that there are a plurality of grounding layers 32 configured on the first substrate 22 in the first trace layer. An insulating layer 31 is configured on each grounding layer 32, and a certain number of the plurality of first sensor traces 13, the plurality of the second sensor traces 14, and/or the plurality of grounding traces 15 can be configured on the insulating layer 31 according to actual needs, and due to the shielding of the grounding layer 32, the interference with the sensor traces 13/14 located above the grounding layer 32 and those located under the grounding layer 32 is isolated. Thus, the corresponding locations on the second substrate 23 of the second trace layer located under the sensor traces 13/14 configured on the insulating layer 31 are no longer required to be empty space. Although there is a space on the insulating layer 31 in FIG. 2(b), this space can be configured with any one of the sensor traces 13/14 and the grounding traces 15. Thus, the first trace layer and the second trace layer in FIG. 2(b) can be filled with the sensor traces 13/14 and the grounding traces 15 according to actual needs, and there is no concern about wasted space. Therefore, the trace area 30 in FIG. 2(b) is obviously narrower than the trace area 10 in FIG. 2(a), and it is possible to configure a relatively larger touch screen on the touch panel 3 when compared with the touch panel 2 of FIG. 2(a).

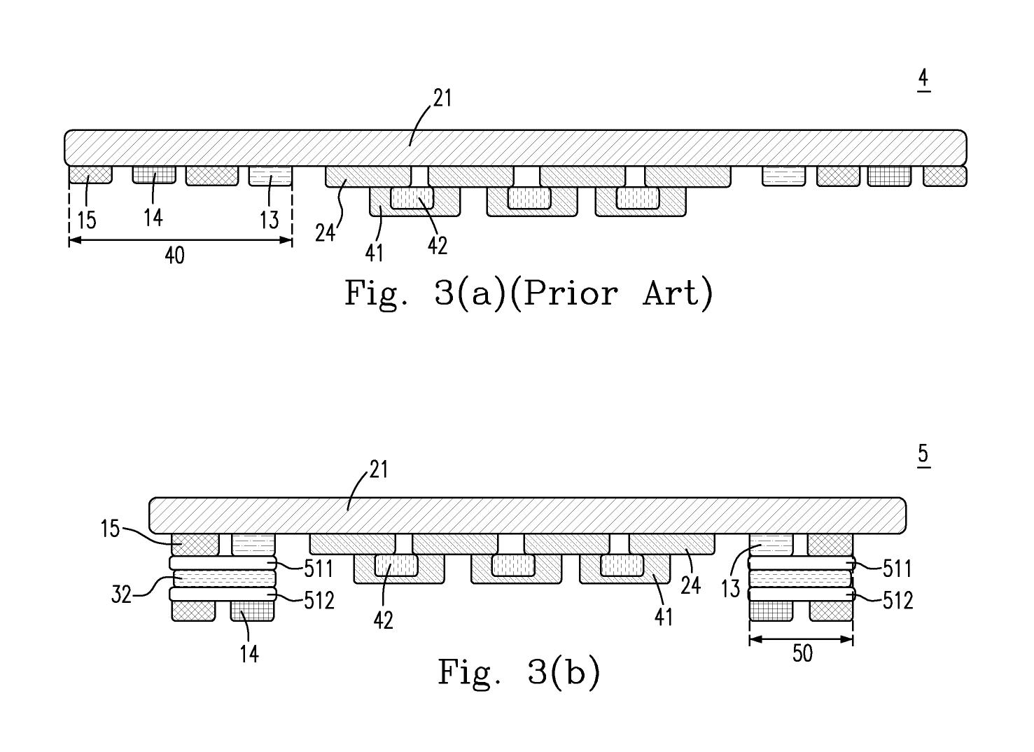

FIG. 3(a) shows a schematic diagram of a trace area and sensors in a conventional touch panel structure. In FIG. 3(a), the touch panel 4 includes a cover glass 21, a plurality of ITO sensors 24, a plurality of electrical connection units for sensors, a plurality of first sensor traces 13, a plurality of second sensor traces 14 and a plurality of grounding traces 15. As shown in FIG. 3(a), the plurality of electrical connection units are configured in the central area under the cover glass 21 to electrically connect two elements inside each sensor. In each electrical connection unit, there is an over coat (OC) 42 inside, and a metal bridge 41 outside. At the left-hand side of FIG. 3(a), there is a trace area 40. One embodiment of this trace area 40 is a rectangular area surrounding the border of the touch panel 4 (refer to the trace area 10 in FIG. 1). As described above, the trace area 40 also includes other embodiments of the non-rectangular area. In the trace area 40, a trace layer is included, wherein the trace layer includes the plurality of first sensor traces 13, the plurality of second sensor traces 14 and the plurality of grounding traces 15. As mentioned above, each first sensor trace 13 is a transmitter trace, each second sensor trace 14 is a receiver trace, and the transmitter trace and the receiver trace can be commonly named as a sensor trace. As described above, in a different embodiment, it is also possible that the first sensor trace 13 is a receiver trace, and the second sensor trace 14 is a transmitter trace. As shown in FIG. 3(a), because there is only a trace layer, and each sensor trace 13/14 and each grounding layer 15 are adjacent to one another, the trace area 40 occupies a relatively wide area. Thus, a substantially amount of space in the trace area 40 is wasted and this can surely be improved.

FIG. 3(b) is a schematic diagram of a cross section of a trace area and sensors in a touch panel structure according to the second preferred embodiment of the present invention. In FIG. 3(b), the touch panel 5 includes a cover glass 21, a plurality of electrical connection units for sensors, a plurality of ITO sensors 24, a plurality of first sensor traces 13, a plurality of second sensor traces 14, a plurality of grounding traces 15, a plurality of first insulating layers 511, a plurality of grounding layers 32, and a plurality of second insulating layers 512. In each electrical connection unit, there is an over coat (OC) 42 inside, and a metal bridge 41 outside. At the right-hand side of FIG. 3(b), there is a trace area 50. The differences between FIG. 3(b) and FIG. 3(a) are that because there is the first insulating layer 511 configured on the first side of each grounding layer 32 of the trace layer, a certain number of the plurality of first sensor traces 13, the plurality of the second sensor traces 14 and the plurality of grounding traces 15 can be configured on the first insulating layer 511 according to actual needs, and a certain number of the plurality of first sensor traces 13, the plurality of the second sensor traces 14 and the plurality of grounding traces 15 can also be configured on the second insulating layer 512 according to actual need also. Because of the shielding of the grounding layer 32, the interference with the sensor traces 13/14 located above the first insulating layer 511 and those located under the second insulating layer 512 is isolated. Thus, the trace area 50 of the touch panel 5 in FIG. 3(b) is relatively narrower than the trace area 40 of the touch panel 4 in FIG. 3(a), and it is possible to configure a relatively larger touch screen on the touch panel 5.

### EMBODIMENTS

1. A touch panel comprising a trace area, wherein the trace area includes:
a grounding layer;
a first insulating layer configured on the grounding layer; and
a first sensor trace configured on the first insulating layer.

2. The touch panel according to Embodiment 1, wherein the trace area further includes a first trace layer and a second trace layer, the first trace layer includes a first substrate, the grounding layer configured on the first substrate, the first insulating layer, a first grounding trace configured on the first insulating layer, and the first sensor trace, the second trace layer includes a second substrate, a second grounding trace and a second sensor trace, the second grounding trace and the second sensor trace are configured on the second substrate, the grounding layer is used to isolate the first sensor trace from the second sensor trace to avoid an interference between the first sensor trace and the second sensor trace, the second grounding trace and the second sensor trace are located under a projection of the grounding layer in space, when the second grounding trace is located right under the first grounding trace, the second sensor trace is located right under the first sensor trace, and when the second grounding trace is located right under the first sensor trace, the second sensor trace is located right under the first grounding trace.

3. The touch panel according to Embodiment 1 or 2, wherein the trace area further includes a trace layer, the trace layer includes the grounding layer, the first insulating layer, the first sensor trace, a first grounding trace, a second insulating layer, a second sensor trace and a second grounding trace, the grounding layer has a first side and a second side, the first insulating layer is configured on the first side, the first sensor trace and the first grounding trace are configured on the first insulating layer, the second insulating layer is configured on the second side, the second sensor trace and the second grounding trace are configured on the second insulating layer, the grounding layer is used to isolate the second sensor trace from a first interference generated by a first signal produced by the first sensor trace, and the first sensor trace from a second interference generated by a second signal produced by the second sensor trace, the second insulating layer is located under a projection of the first insulating layer in space, when the second grounding trace is located right under the first grounding trace, the second sensor trace is located right under the first sensor trace, and when the second grounding trace is located right under the first sensor trace, the second sensor trace is located right under the first grounding trace.

4. The touch panel according to Embodiment 1, wherein the trace area further includes:
a first trace layer having a first substrate, the grounding layer configured on the first substrate, the first insulating layer and the first sensor trace; and
a second trace layer parallel to the first trace layer and having:
   a second substrate;
   a first grounding trace; and
   a second sensor trace, wherein the first grounding trace and the second sensor trace are configured on the second substrate, the first grounding trace and the second sensor trace are located under a projection of the grounding layer in space, and the grounding layer is used to isolate the first sensor trace from the second sensor trace to avoid an interference between the first sensor trace and the second sensor trace.

5. The touch panel according to Embodiment 1 or 4, wherein the first trace layer further includes a second grounding trace configured on the first insulating layer, when the first grounding trace is located right under the second grounding trace, the second sensor trace is located right under the first sensor trace, and when the first grounding trace is located right under the first sensor trace, the second sensor trace is located right under the second grounding trace.

6. The touch panel according to Embodiment 1, wherein the trace area further includes:
a first grounding trace configured on the first insulating layer, wherein the grounding layer has a first side and a second side, and the first insulating layer is configured on the first side;
a second insulating layer configured on the second side;
a second sensor trace; and
a second grounding trace, wherein the second sensor trace and the second grounding trace are configured on the second insulating layer, and the second insulating layer is located under a projection of the first insulating layer in space.

7. The touch panel according to Embodiment 1 or 6, wherein the grounding layer is used to isolate the second sensor trace from a first interference generated by a first signal produced by the first sensor trace, and to isolate the first sensor trace from a second interference generated by a second signal produced by the second sensor trace, when the second grounding trace is located right under the first grounding trace, the second sensor trace is located right under the first sensor trace, and when the second grounding trace is located right under the first sensor trace, the second sensor trace is located right under the first grounding trace.

8. A touch panel comprising a trace area, wherein the trace area includes a cross section and the cross section includes by height:
a first trace layer;
a second trace layer; and
an insulating layer configured between the first trace layer and the second trace layer.

9. The touch panel according to Embodiment 8, wherein the first trace layer includes a first substrate, a grounding layer configured on the first substrate, the insulating layer configured on the grounding layer, a first grounding trace configured on the insulating layer, and a first sensor trace configured on the insulating layer, the second trace layer includes a second substrate, a second grounding trace and a second sensor trace, the second grounding trace and the second sensor trace are configured on the second substrate, the grounding layer is used to isolate the first sensor trace from the second sensor trace to avoid an interference between the first sensor trace and the second sensor trace, the second grounding trace and the second sensor trace are located under a projection of the grounding layer in space, when the second grounding trace is located right under the first grounding trace, the second sensor trace is located right under the first sensor trace, and when the second grounding trace is located right under the first sensor trace, the second sensor trace is located right under the first grounding trace.

10. The touch panel according to Embodiment 8, wherein the trace area further includes a grounding layer, the insulating layer is a first insulating layer, the first trace layer includes the first insulating layer, a first sensor trace and a first grounding trace, the second trace layer includes a second insulating layer, a second sensor trace and a second grounding trace, the grounding layer has a first side and a second side, the first insulating layer is configured on the first side, the first sensor trace and the first grounding trace are configured on the first insulating layer, the second insulating layer is configured on the second side, the second sensor trace and the second grounding trace are configured on the second insulating layer, the grounding layer is used to isolate the second sensor trace from a first interference generated by a first signal produced by the first sensor trace, and the first sensor trace from a second interference generated by a second signal produced by the second sensor trace, the second insulating layer is located under a projection of the first insulating layer in space, when the second grounding trace is located right under the first grounding trace, the second sensor trace is located right under the first sensor trace, and when the second grounding trace is located right under the first sensor trace, the second sensor trace is located right under the first grounding trace.

11. A manufacturing method for a touch panel, comprising:
providing a trace area including a grounding layer, a first insulating layer and a first sensor trace;
configuring the first insulating layer on the grounding layer; and
configuring the first sensor trace on the first insulating layer.

12. The manufacturing method according to Embodiment 11, wherein the trace area further includes a first trace layer and a second trace layer parallel to the first trace layer, the first trace layer includes a first substrate, the grounding layer, the first insulating layer, a first grounding trace and the first sensor trace, the second trace layer includes a second substrate, a second grounding trace and a second sensor trace, and the manufacturing method further includes:
configuring the grounding layer on the first substrate;
configuring the first grounding trace on the first insulating layer; and
configuring the second grounding trace and the second sensor trace on the second substrate such that the second grounding trace and the second sensor trace are located under the projection of the grounding layer in space, wherein the grounding layer is used to isolate the first sensor trace from the second sensor trace to avoid an interference between the first sensor trace and the second sensor trace, when the second grounding trace is located right under the first grounding trace, the second sensor trace is located right under the first sensor trace, and when the second grounding trace is located right under the first sensor trace, the second sensor trace is located right under the first grounding trace.

13. The manufacturing method according to Embodiment 11, wherein the trace area further includes a trace layer, the trace layer includes the grounding layer, the first insulating layer, the first sensor trace, a first grounding trace, a second insulating layer, a second sensor trace and a second grounding trace, and the grounding layer has a first side and a second side, the manufacturing method further including:
configuring the first insulating layer on the first side;
configuring the first sensor trace and the first grounding trace on the first insulating layer;
configuring the second insulating layer on the second side and located under a projection of the first insulating layer in space; and
configuring the second sensor trace and the second grounding trace on the second insulating layer, wherein the grounding layer is used to isolate the second sensor trace from a first interference generated by a first signal produced by the first sensor trace, and the first sensor trace from a second interference generated by a second signal produced by the second sensor trace, when the second grounding trace is located right under the first grounding trace, the second sensor trace is located right under the first sensor trace, and when the second grounding trace is located right under the first sensor trace, the second sensor trace is located right under the first grounding trace.

14. The manufacturing method according to Embodiment 11, further comprising:
providing a first trace layer and a second trace layer to cause the grounding layer to be located between the first trace layer and the second trace layer; and
causing the first trace layer and the second trace layer to be located at different vertical levels.

15. The manufacturing method according to Embodiment 11 or 14, wherein the trace area further includes the first trace layer, the second trace layer and the grounding layer, the first trace layer includes a first substrate, the first insulating layer, a first grounding trace and the first sensor trace, the second trace layer includes a second substrate, a second grounding trace and a second sensor trace, the grounding layer is configured on the first substrate, the grounding layer is used to isolate the first sensor trace from the second sensor trace to avoid an interference between the first sensor trace and the second sensor trace, the second grounding trace and the second sensor trace are configured on the second substrate, the second grounding trace and the second sensor trace are located under a projection of the grounding layer in space, when the second grounding trace is located right under the first grounding trace, the second sensor trace is located right under the first sensor trace, and when the second grounding trace is located right under the first sensor trace, the second sensor trace is located right under the first grounding trace.

16. The manufacturing method according to Embodiment 11 or 14, wherein the trace area further includes the first trace layer, the second trace layer and the grounding layer, the first trace layer includes the first insulating layer, the first sensor trace and a first grounding trace, the second trace layer includes a second insulating layer, a second sensor trace and a second grounding trace, the grounding layer has a first side and a second side, the first insulating layer is configured on the first side, the first grounding trace is configured on the first insulating layer, the second insulating layer is configured on the second side, the second sensor trace and the second grounding trace are configured on the second insulating layer, the grounding layer is used to isolate the second sensor trace from a first interference generated by a first signal produced by the first sensor trace, and isolate the first sensor trace from a second interference generated by a second signal produced by the second sensor trace, the second insulating layer is located under a projection of the first insulating layer in space, when the second grounding trace is located right under the first grounding trace, the second sensor trace is located right under the first sensor trace, and when the second grounding trace is located right under the first sensor trace, the second sensor trace is located right under the first grounding trace.

According to the descriptions above, the present invention discloses a touch panel having a trace area with a first trace layer and a second trace layer, wherein the first trace layer and the second trace layer area are located at different vertical levels, and the touch panel has a relatively narrow frame such that a relatively large touch screen can be configured, which demonstrates the non-obviousness and novelty.

While the invention has been described in terms of what is presently considered to be the most practical and preferred embodiments, it is to be understood that the invention needs not be limited to the disclosed embodiments. Therefore, it is intended to cover various modifications and similar configuration included within the spirit and scope of the appended claims, which are to be accorded with the broadest interpretation so as to encompass all such modifications and similar structures.

What is claimed is:

1. A touch panel comprising a trace area, wherein the trace area includes:
a grounding layer;
a first insulating layer configured on the grounding layer; and
a first sensor trace configured on the first insulating layer.

2. The touch panel according to claim 1, wherein the trace area further includes a first trace layer and a second trace layer, the first trace layer includes a first substrate, the grounding layer configured on the first substrate, the first insulating layer, a first grounding trace configured on the first insulating layer, and the first sensor trace, the second trace layer includes a second substrate, a second grounding trace and a second sensor trace, the second grounding trace and the second sensor trace are configured on the second substrate, the grounding layer is used to isolate the first sensor trace from the second sensor trace to avoid an interference between the first sensor trace and the second sensor trace, the second grounding trace and the second sensor trace are located under a projection of the grounding layer in space, when the second grounding trace is located right under the first grounding trace, the second sensor trace is located right under the first sensor trace, and when the second grounding trace is located right under the first sensor trace, the second sensor trace is located right under the first grounding trace.

3. The touch panel according to claim 1, wherein the trace area further includes a trace layer, the trace layer includes the grounding layer, the first insulating layer, the first sensor trace, a first grounding trace, a second insulating layer, a second sensor trace and a second grounding trace, the grounding layer has a first side and a second side, the first insulating layer is configured on the first side, the first sensor trace and the first grounding trace are configured on the first insulating layer, the second insulating layer is configured on the second side, the second sensor trace and the second grounding trace are configured on the second insulating layer, the grounding layer is used to isolate the second sensor trace from a first interference generated by a first signal produced by the first sensor trace, and the first sensor trace from a second interference generated by a second signal produced by the second sensor trace, the second insulating layer is located under a projection of the first insulating layer in space, when the second grounding trace is located right under the first grounding trace, the second sensor trace is located right under the first sensor trace, and when the second grounding trace is located right under the first sensor trace, the second sensor trace is located right under the first grounding trace.

4. The touch panel according to claim 1, wherein the trace area further includes:
a first trace layer having a first substrate, the grounding layer configured on the first substrate, the first insulating layer and the first sensor trace; and
a second trace layer parallel to the first trace layer and having:
a second substrate; and
a second sensor trace, wherein the second sensor trace is configured on the second substrate, the second sensor trace is located under a projection of the grounding layer in space, and the grounding layer is used to isolate the first sensor trace from the second sensor trace to avoid an interference between the first sensor trace and the second sensor trace.

5. The touch panel according to claim 4, wherein the second trace layer further includes a first grounding trace, the first grounding trace is configured on the second substrate, and the first grounding trace and the second sensor trace are located under a projection of the grounding layer in space.

6. The touch panel according to claim 5, wherein the first trace layer further includes a second grounding trace configured on the first insulating layer, when the first grounding trace is located right under the second grounding trace, the second sensor trace is located right under the first sensor trace, and when the first grounding trace is located right under the first sensor trace, the second sensor trace is located right under the second grounding trace.

7. The touch panel according to claim 1, wherein the grounding layer has a first side and a second side, the first insulating layer is configured on the first side, and the trace area further includes:
a second insulating layer configured on the second side; and
a second sensor trace, wherein the second sensor trace is configured on the second insulating layer, and the second insulating layer is located under a projection of the first insulating layer in space.

8. The touch panel according to claim 7, wherein the trace area further includes:
a first grounding trace configured on the first insulating layer; and
a second grounding trace, wherein the second sensor trace and the second grounding trace are configured on the second insulating layer, and the second insulating layer is located under a projection of the first insulating layer in space.

9. The touch panel according to claim 8, wherein the grounding layer is used to isolate the second sensor trace from a first interference generated by a first signal produced by the first sensor trace, and to isolate the first sensor trace from a second interference generated by a second signal produced by the second sensor trace, when the second grounding trace is located right under the first grounding trace, the second sensor trace is located right under the first sensor trace, and when the second grounding trace is located right under the first sensor trace, the second sensor trace is located right under the first grounding trace.

10. A touch panel comprising a trace area, wherein the trace area includes a cross section and the cross section includes by height:
a first trace layer;
a second trace layer; and
an insulating layer configured between the first trace layer and the second trace layer.

11. The touch panel according to claim 10, wherein the first trace layer includes a first substrate, a grounding layer configured on the first substrate, the insulating layer configured on the grounding layer, a first grounding trace configured on the insulating layer, and a first sensor trace configured on the insulating layer, the second trace layer includes a second substrate, a second grounding trace and a second sensor trace, the second grounding trace and the second sensor trace are configured on the second substrate, the grounding layer is used to isolate the first sensor trace from the second sensor trace to avoid an interference between the first sensor trace and the second sensor trace, the second grounding trace and the second sensor trace are located under a projection of the grounding layer in space, when the second grounding trace is located right under the first grounding trace, the second sensor trace is located right under the first sensor trace, and when the second grounding trace is located right under the first sensor trace, the second sensor trace is located right under the first grounding trace.

12. The touch panel according to claim 10, wherein the trace area further includes a grounding layer, the insulating layer is a first insulating layer, the first trace layer includes the first insulating layer, a first sensor trace and a first grounding trace, the second trace layer includes a second insulating layer, a second sensor trace and a second grounding trace, the grounding layer has a first side and a second side, the first insulating layer is configured on the first side, the first sensor trace and the first grounding trace are configured on the first insulating layer, the second insulating layer is configured on the second side, the second sensor trace and the second grounding trace are configured on the second insulating layer, the grounding layer is used to isolate the second sensor trace from a first interference generated by a first signal produced by the first sensor trace, and the first sensor trace from a second interference generated by a second signal produced by the second sensor trace, the second insulating layer is located under a projection of the first insulating layer in space, when the second grounding trace is located right under the first grounding trace, the second sensor trace is located right under the first sensor trace, and when the second grounding trace is located right under the first sensor trace, the second sensor trace is located right under the first grounding trace.

13. A manufacturing method for a touch panel, comprising:
providing a trace area including a grounding layer, a first insulating layer and a first sensor trace;
configuring the first insulating layer on the grounding layer; and
configuring the first sensor trace on the first insulating layer.

14. The manufacturing method according to claim 13, wherein the trace area further includes a first trace layer and a second trace layer parallel to the first trace layer, the first trace layer includes a first substrate, the grounding layer, the first insulating layer, a first grounding trace and the first sensor trace, the second trace layer includes a second substrate, a second grounding trace and a second sensor trace, and the manufacturing method further includes:
configuring the grounding layer on the first substrate;
configuring the first grounding trace on the first insulating layer; and
configuring the second grounding trace and the second sensor trace on the second substrate such that the second grounding trace and the second sensor trace are located under the projection of the grounding layer in space, wherein the grounding layer is used to isolate the first sensor trace from the second sensor trace to avoid an interference between the first sensor trace and the second sensor trace, when the second grounding trace is located right under the first grounding trace, the second sensor trace is located right under the first sensor trace, and when the second grounding trace is located right under the first sensor trace, the second sensor trace is located right under the first grounding trace.

15. The manufacturing method according to claim 13, wherein the trace area further includes a trace layer, the trace layer includes the grounding layer, the first insulating layer, the first sensor trace, a first grounding trace, a second insulating layer, a second sensor trace and a second grounding trace, and the grounding layer has a first side and a second side, the manufacturing method further including:
configuring the first insulating layer on the first side;
configuring the first sensor trace and the first grounding trace on the first insulating layer;
configuring the second insulating layer on the second side and located under a projection of the first insulating layer in space; and
configuring the second sensor trace and the second grounding trace on the second insulating layer, wherein the grounding layer is used to isolate the second sensor trace from a first interference generated by a first signal produced by the first sensor trace, and the first sensor trace from a second interference generated by a second signal produced by the second sensor trace, when the second grounding trace is located right under the first grounding trace, the second sensor trace is located right under the first sensor trace, and when the second grounding trace is located right under the first sensor trace, the second sensor trace is located right under the first grounding trace.

16. The manufacturing method according to claim 13, further comprising:
providing a first trace layer and a second trace layer to cause the grounding layer to be located between the first trace layer and the second trace layer; and
causing the first trace layer and the second trace layer to be located at different vertical levels.

17. The manufacturing method according to claim 16, wherein the trace area further includes the first trace layer, the second trace layer and the grounding layer, the first trace layer includes a first substrate, the first insulating layer, a first grounding trace and the first sensor trace, the second trace layer includes a second substrate, a second grounding trace and a second sensor trace, the grounding layer is configured on the first substrate, the grounding layer is used to isolate the first sensor trace from the second sensor trace to avoid an interference between the first sensor trace and the second sensor trace, the second grounding trace and the second sensor trace are configured on the second substrate, the second grounding trace and the second sensor trace are located under a projection of the grounding layer in space, when the second grounding trace is located right under the first grounding trace, the second sensor trace is located right under the first sensor trace, and when the second grounding trace is located right under the first sensor trace, the second sensor trace is located right under the first grounding trace.

18. The manufacturing method according to claim 16, wherein the trace area further includes the first trace layer, the second trace layer and the grounding layer, the first trace layer includes the first insulating layer, the first sensor trace and a first grounding trace, the second trace layer includes a second insulating layer, a second sensor trace and a second grounding trace, the grounding layer has a first side and a second side, the first insulating layer is configured on the first side, the first grounding trace is configured on the first insulating layer, the second insulating layer is configured on the second side, the second sensor trace and the second grounding trace are configured on the second insulating layer, the grounding layer is used to isolate the second sensor trace from a first interference generated by a first signal produced by the first sensor trace, and isolate the first sensor trace from a second interference generated by a second signal produced by the second sensor trace, the second insulating layer is located under a projection of the first insulating layer in space, when the second grounding trace is located right under the first grounding trace, the second sensor trace is located right under the first sensor trace, and when the second grounding trace is located right under the first sensor trace, the second sensor trace is located right under the first grounding trace.
